(19) United States
(12) Patent Application Publication
(10) Pub. No.: US 2013/0164519 A1
(43) Pub. Date: Jun. 27, 2013

(54) FLAME RETARDANT POLYURETHANE ELASTOMER, FIBER AND TEXTILE FORMED THEREFROM, AND METHOD FOR THEIR PRODUCTION

(71) Applicant: Alan DAVIS, Northport, AL (US)

(72) Inventor: Alan DAVIS, Northport, AL (US)

(73) Assignee: RADICISPANDEX CORPORATION, Gastonia, NC (US)

(21) Appl. No.: 13/334,790

(22) Filed: Dec. 22, 2011

(51) Int. Cl. B32B 5/02; C08K 5/20; B29C 47/88; C08G 18/32

(52) U.S. Cl. 428/221; 525/453; 525/459; 524/500; 524/233; 264/211.12

(57) ABSTRACT

A flame retardant polyurethane elastomer composition containing an oligomeric phosphate obtained by reaction of a trialkyl phosphate with phosphorous pentoxide and an epoxides is provided. In a preferred embodiment, the polyurethane elastomer is a spandex. A method to prepare a fiber or yarn of the flame retardant elastomer and a fabric containing the fiber or yarn is also provided.

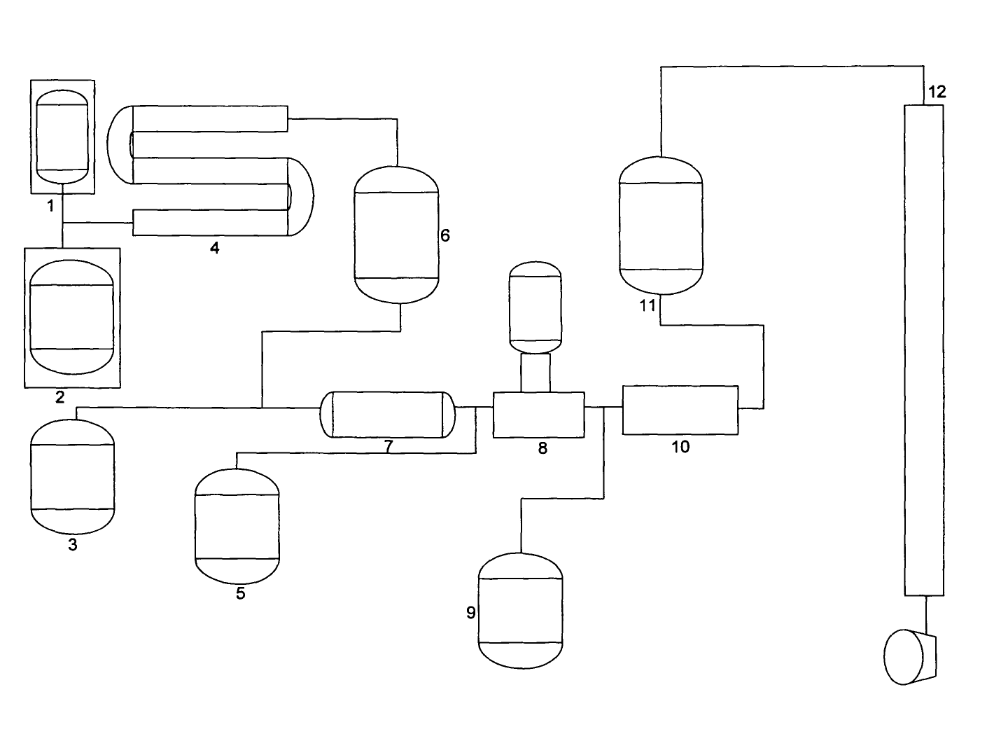

### BACKGROUND OF THE INVENTION

1. Field of the Invention

The present invention relates to a polyurethane elastomer composition having flame retardant property, a method to prepare the composition, fiber comprising the composition and a fabric comprising the fiber.

2. Discussion of the Background

Elastomeric polyurethanes are conventionally employed throughout the textile industry to prepare textile fabrics having good stretch and recovery properties. Commonly employed elastomeric polyurethanes are generically described as spandex, a term applied to a host of polyurethanes constructed of soft and rubbery segments of polyester or polyether polyols and hard segments of urethane or urethane-urea units. These hard segments provide rigidity and tensile strength to fibers prepared from the elastic polyurethane while the soft segments allow the fiber to stretch up to 600% and yet recover the original shape when tension is relaxed.

Typically the elastomeric polyurethanes such as spandex have been blended at a maximum level of approximately 20% by weight with other synthetic fibers or natural fibers such as cotton, wool, silk and linen in the preparation of finished textiles, most commonly in the undergarment and athletic wear industries. However, recent developments in the industry are leading to introduction to or increased utility of elastomeric polyurethanes into other applications such as more formal clothing segments, upholstery and automotive coverings. The expansion of utility of elastomeric polyurethanes to an even wider range of applications would be facilitated and promoted if an elastomeric fiber having flame retardant properties were available. However, polyurethane elastomer fibers, including spandex fibers, having flame retardant properties are not readily available and a need exists in the industry for such fibers.

Polyurethane foams having flame retardance are generally described in the Kirk-Othmer Encyclopedia of Chemical Technology (Fifth Edition, Vol. 25, page 469). Flame retardants are either of the reactive type, such as reactive diols which are chemically incorporated into the polymer network or nonreactive types which are physically blended with the polyurethane composition. Examples of such physical blend materials are mineral fillers such as alumina trihydrate and organic fillers such as melamine. However, typical reactive type flame retardants are not useful in elastomeric polyurethanes because such would be detrimental to the stretch and other physical properties of the fiber. Conventional nonreactive flame retardant additives are either not compatible with the elastomeric polyurethane or may react with polymer linkages leading to degradation of the polymer and its performance.

Rock et al. (U.S. Pat. No. 7,776,421) describes composite velour fabric garment which includes a laminate consisting of an outer woven shell layer containing spandex in at least a weft direction for stretch and recovery in a width direction. The outer shell layer comprises flame retardant fibers, e.g. formed of one or more materials selected from the group consisting of: aramides, melamines, FR polyesters, inherent flame retardant materials, and blends thereof. Flame retardant fibers include aramides, e.g. as sold under the trademark NOMEX® by E.I. du Pont de Nemours and Co., Inc., of Wilmington, Del., or blends of fibers, such as NOMEX® (aramide fibers), KEVLAR® (para-aramide fibers, also available from E.I. du Pont). Nowhere does this reference disclose or suggest a polyurethane elastomer composition or fiber having flame retardant property.

The use of oliogomeric phosphoric acid esters to provide flame resistance to polyurethane foams has been described. For example, Sicken et al. (U.S. Pat. No. 5,985,965) describe flame-resistant polyurethanes containing as flameproofing agents, mixtures of oligomeric phosphoric acid esters which carry hydroxyalkoxy groups. The oligomeric phosphoric acid esters are prepared by reaction of a trialkyl phosphate with phosphorous pentoxide, then partially hydrolyzing or glycolyzing formed P-O-P bonds and reacting the resulting partial ester with an epoxides.

Bradford et al. (U.S. Pat. No. 6,262,135) describes a flame retardant blend for use in a polyurethane foam containing a monomeric halogenated compound and an oligomeric organophosphate. The oligomeric organophosphate is obtained by reaction of a trialkyl phosphate with phosphorous pentoxide to form a polyphosphate ester which is further reacted with an epoxide such as ethylene oxide.

Bradford et al. (U.S. Pat. No. 7,288,577) further describes a non-halogen containing flame retardant blend for use in a polyurethane foam containing a phosphate ester and the oligomeric organophosphate described in U.S. Pat. No. 6,262,135.

However, none of the cited references discloses or suggests a flame retardant polyurethane elastomer composition, comprising a polyurethane-urea elastomer; and an oligomeric phosphate obtained by reaction of a trialkyl phosphate with phosphorous pentoxide and an epoxide.

### SUMMARY OF THE INVENTION

Accordingly, one objective of the present invention is to provide a polyurethane elastomer composition having flame retardant property. As used herein, the term flame-retardant refers to fabrics and other materials that, due to chemical treatment or inherent properties, do not ignite readily or propagate flaming under small-to-moderate fire exposure. See, e.g., Fire Protection Handbook (17.sup.th Edition), National Fire Protection Association, Quincy, Mass., 1992. (p. 3-174).

A further objective of the present invention is to provide a fiber of a elastomeric polyurethane having flame retardant property.

Another objective of the present invention is to provide a method to prepare a polyurethane elastomer composition having flame retardant property.

A still further objective of the present invention is to provide a method for preparing a fiber of a elastomeric polyurethane having flame retardant property.

A further objective is to provide a yarn containing a fiber of a elastomeric polyurethane having flame retardant property.

An additional objective is to provide a fabric made from at least the fiber or yarn of the present invention in an amount sufficient to provide stretch properties along with maintaining flame retardancy.

These and other objects, individually or in combinations thereof, have been achieved by the present invention, a first embodiment of which includes a polyurethane elastomer composition, comprising a polyurethane-urea elastomer; and an oligomeric phosphate obtained by reaction of a trialkyl phosphate with phosphorous pentoxide and an epoxide.

A second embodiment of the present invention provides polyurethane elastomer composition comprising a polyurethane-urea elastomer obtained by polymerization of monomer components, comprising an aromatic diisocyanate; a polyether glycol and an alkyl amine having at least two nitrogens with hydrogen reactive to isocyanate groups wherein the composition contains a flame retardant effective amount of an oligomeric phosphate obtained by reaction of a trialkyl phosphate with phosphorous pentoxide and an epoxide.

In a preferred embodiment the present invention provides a flame retarded polyurethane-urea elastomer composition containing a flame retardant effective amount of an oligomeric phosphate obtained by reaction of a trialkyl phosphate with phosphorous pentoxide and an epoxide wherein the polyurethane-urea elastomer is obtained by polymerizing 4,4′-diphenylmethane-diisocyanate, a polytetramethylene ether glycol (PTMEG) having a molecular weight of from 1800 to 2200 and an alkyl amine selected from the group consisting of ethylene diamine, propylene diamine and diethylenetriamine.

In a further preferred embodiment, the present invention provides a method for preparing a flame retarded polyurethane-urea elastomer composition by addition of an oligomeric phosphate obtained by reaction of a trialkyl phosphate with phosphorous pentoxide and an epoxide to a solution comprising at least a polyurethane elastomer and a solvent, extruding the solution of the polyurethane elastomer and oligomeric phosphate and removing the solvent to obtain the flame retarded polyurethane elastomer.

In an especially preferred embodiment the present invention the flame retarded polyurethane elastomer is extruded in the form of a fiber. The fiber may then be spun into a yarn. The fiber or yarn can be used to prepare flame retardant fabrics containing the fiber or yarn of the present invention, preferably in combination with one or more other flame retardant yarns.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings and examples.

### BRIEF DESCRIPTION OF THE DRAWINGS

The FIGURE shows a process map for production of polyurethane-urea elastomer fibers according to one embodiment of the invention.

### DETAILED DESCRIPTION OF THE INVENTION

Applicants have recognized the need for a flame retardant polyurethane elastomer composition, especially a composition of a polyurethane-urea elastomer such as spandex. Surprisingly, Applicants have discovered that a flame retardant property may be added to a polyurethane-urea elastomer composition by adding an oligomeric phosphate obtained by reaction of a trialkyl phosphate with phosphorous pentoxide and an epoxide to a solvent solution of the polyurethane-urea elastomer prior to extruding the elastomer and removing the solvent.

Thus, in a first embodiment, the present invention provides a polyurethane elastomer composition, comprising a polyurethane-urea elastomer; and an oligomeric phosphate obtained by reaction of a trialkyl phosphate with phosphorous pentoxide and an epoxide.

A second embodiment of the present invention provides polyurethane elastomer composition comprising a polyurethane-urea elastomer obtained by polymerization of monomer components, comprising an aromatic diisocyanate; a polyether glycol and an alkyl amine having at least two nitrogens with hydrogen reactive to isocyanate groups wherein the composition contains a flame retardant effective amount of an oligomeric phosphate obtained by reaction of a trialkyl phosphate with phosphorous pentoxide and an epoxide.

The aromatic diisocyanate may be one or more selected from the group consisting of 2,4-toluene-diisocyanate, 2,6-toluene-diisocyanate, 4,4′-diphenylmethane-diisocyanate, 2,4′-diphenylmethane-diisocyanate and 2,2′-diphenylmethane-diisocyanate. In a preferred embodiment, the aromatic diisocyanate is 4,4′-diphenylmethane-diisocyanate (MDI).

The polyether glycol may preferably be a polytetramethylene glycol (PTMEG), more preferably a PTMEG having a molecular weight of from 1800 to 2200.

The alkyl amine having at least two nitrogens with hydrogen reactive to isocyanate groups may be one or more selected from the group consisting of ethylene diamine, propylene diamine and diethylenetriamine.

In a preferred embodiment the present invention provides a flame retarded polyurethane-urea elastomer composition containing a flame retardant effective amount of an oligomeric phosphate obtained by reaction of a trialkyl phosphate with phosphorous pentoxide and an epoxide wherein the polyurethane-urea elastomer is obtained by polymerizing 4,4′-diphenylmethane-diisocyanate, a polytetramethylene ether glycol (PTMEG) having a molecular weight of from 1800 to 2200 and an alkyl amine selected from the group consisting of ethylene diamine, propylene diamine and diethylenetriamine.

The trialkyl phosphate may be selected from C1 to C10 trialkyl phosphates. C2 to C4 trialkyl phosphates may be preferred and triethyl phosphate may be especially preferred.

The epoxide reacted with the trialkyl phosphate and phosphorous pentoxide may preferably be ethylene oxide.

A content of the oligomeric phosphate may be from 0.1 to 6% by weight based on the weight of the polyurethane-urea elastomer, preferably 0.5 to 3% and most preferably 1.0 to 1.6%.

The polyurethane elastomer composition may further comprise at least one additive selected from the group consisting of an antioxidant, a colorant, a metal scavenger, a lubricant, a plasticizer and a spin processing aid in a content which does not adversely affect the performance properties of the polyurethane elastomer composition.

In a further preferred embodiment, the present invention provides a method for preparing a flame retarded polyurethane-urea elastomer composition comprising addition of an oligomeric phosphate obtained by reaction of a trialkyl phosphate with phosphorous pentoxide and an epoxide to a solution comprising at least a polyurethane elastomer and a solvent, extruding the solution of the polyurethane elastomer and oligomeric phosphate; and removing the solvent to obtain the flame retarded polyurethane elastomer.

The FIGURE shows a diagram of equipment order and materials flow to prepare a flame-retarded polyurethane-urea elastomer spun fiber according to one embodiment of the present invention. Diisocyanate and glycol raw materials supplied from supply tanks (1) and (2), respectively are initially reacted in pre-polymer reactor (4) and the formed pre-polymer stored in tank (6). The pre-polymer is blended in a solvent supplied from solvent supply tank (3) in dilution mixer (7). The prepolymer blend is reacted with the alkyl amine supplied from tank (5) in polymerization reactor (8). Following polymerization, an additive dispersion supplied from dispersion vessel (9) is mixed with the polymer solution in additive mixer (10) and the pre-spinning mixture stored in unit (11). From the storage unit (11), the polymer additive solvent pre-spinning mixture is transferred to spinning cell (12) to produce a spun fiber.

The oligomeric phosphate composition can be introduced in the method of producing the elastomer composition in any desired location during production after the polymerization reactor 8, so long as the oligomeric phosphate composition will be homogeneously mixed with the remainder of the elastomer composition. Accordingly, the oligomeric phosphate composition is preferably introduced in any one or more of the following locations:
at the addition of dispersed additives between the polymererization reactor (8) and additive mixer (10);
in the additive mixer (10) itself;
between the additive mixer (10) and the polymer storage unit;
in the line between the storage unit (11) and the spinning cell (12) for spinning of the fibers; or
directly into the spinning head of the spinning cell (12) just prior to spinning of the fibers.

At least one additive selected from the group consisting of an antioxidant, a colorant, a metal scavenger, a lubricant, a plasticizer and a spin processing aid may be added to the capped glycol prepolymer solution or the polyurethane-urea elastomer solution.

The polyurethane-urea elastomer solution may then be extruded through a die to form a fiber, or preferably through a multihole die to form yarn.

In a highly preferred embodiment, the polyurethane-urea elastomer is a spandex prepared by a process comprising:

reacting the 4,4′-diphenylmethane-diisocyanate with the PTMEG having a molecular weight of from 1800 to 2200 to obtain a capped glycol prepolymer; and polymerizing the capped glycol prepolymer by reaction with the alkyl amine having at least two nitrogens with hydrogen reactive to isocyanate groups to obtain the polyurethane-urea elastomer.

According to the highly preferred embodiment the alkyl amine having at least two nitrogens with hydrogen reactive to isocyanate groups is selected from the group consisting of ethylene diamine, propylene diamine and diethylenetriamine, and a content of the 4,4′-diphenylmethane-diisocyanate is from 16.0 to 20.0 weight %, and a content of the PTMEG is 80 to 84 weight %, relative to a total mass of the PTMEG and 4,4′-diphenylmethane-diisocyanate.

According to the highly preferred embodiment, the prepared capped glycol prepolymer is dissolved in dimethylacetamide (DMAc) to a concentration of the capped glycol prepolymer in the DMAc from 30 to 50 weight %, preferably 32 to 40 weight % and most preferably, 34 to 38 weight %, to adjust the viscosity for extrusion of the solution in a spinning cell. The dimethacetamide solution of the polyurethane-urea elastomer comprising the oligomeric phosphate obtained by reaction of triethyl phosphate, phosphorous pentoxide and ethylene oxide may be extruded through a die to form a fiber and the fiber heat treated at a temperature of 190 to 385° C. to remove the dimethacetamide from the formed flame retardant polymer fiber.

The flame retardant fiber according to the invention may be spun into a yarn and textile articles prepared from the yarn. The fiber of the present invention (also known as filament) can have any desired denier, preferably from 10 to 20 denier, more preferably from 10 to 18 denier. The resulting yarn will typically have from 1 to 96 fibers (or filaments), with a preferred composite denier of from 10 to 1680 denier, more preferably 10 to 1400 denier, most preferably from 20 to 140 denier.

The fiber or yarn of the present invention can be used to prepare fabrics having stretch properties, while maintaining flame retardant properties. The fabrics of the present invention can contain any desired level of yarn made from the flame retardant polyurethane elastomer of the present invention. Preferably, the amount of yarn of the present invention in a given fabric is in a range of from 1 to 50% by weight, with the remainder of the yarn in the fabric being conventional flame retardant yarn (referred to as “hard yarns” due to their lack or, or lower level of, elastomeric properties). These flame retardant hard yarns can be any conventional FR yarn, including but not limited to, FR polyester, FR nylon, FR acrylic, etc. In preferred embodiments, the fabric is useful for clothing and contains from 2 to 35% by weight, more preferably from 5 to 20% by weight, most preferably from 9 to 14% by weight, of the flame retardant polyurethane elastomer yarn of the present invention, with the remainder being one or more FR hard yarns. The fabric can be prepared by any desired method, and is preferably knit.

Burn tests using fabrics from the present invention provide flame resistance measurements that meet or exceed ASTM D-6413 standards. Burn tests on a pre-formed bar made entirely of the present invention flame retardant polyurethane elastomer gave total combustion times 3-6 times shorter than comparable bars formed of the same polyurethane elastomer without the presence of the oligomeric phosphate obtained by reaction of a trialkyl phosphate with phosphorous pentoxide and an epoxide (flame retardant).

Having generally described this invention, a further understanding can be obtained by reference to certain specific examples which are provided herein for purposes of illustration only and are not intended to be limiting unless otherwise specified.

### EXAMPLES

### Example 1

A mixture of 18.2% by weight of 4,4′-diphenylmethane-diisocyanate (MDI) and polytetramethylene ether glycol (PTMEG) having a molecular weight 2000 is homogeneously blended by pumping through a static ribbon mixer. The mixture is pumped into a continuous reactor at a flow rate of 125 lbs/hr at a reactor temperature of 85° C. The capped glycol prepolymer obtained is collected in a mixing vessel and blended with dimethylacetamide (DMAc) at a weight ratio of 63.5% DMAc to 36.5% capped glycol prepolymer. The diluted capped glycol prepolymer is polymerized with the addition of ethylene diamine to obtain solution of elastomer polyurethane-urea. A polymeric mixture obtained by reaction of triethyl phosphate, phosphorous pentoxide and ethylene oxide is added to the elastomer polyurethane-urea solution at a rate of 1.4% by weight based on the weight of the elastomer polyurethane-urea and the mixture is blended. The blended mixture is then pumped under 450 psig through a spinning cell to form a fiber.

1. A polyurethane elastomer composition, comprising:
a polyurethane-urea elastomer; and
an oligomeric phosphate obtained by reaction of a trialkyl phosphate with phosphorous pentoxide and an epoxide.

2. The polyurethane elastomer composition according to claim 1, wherein
the polyurethane-urea elastomer is a polymer obtained by polymerization of monomer components, comprising:
an aromatic diisocyanate;
a polyether glycol; and
an alkyl amine having at least two nitrogens with hydrogen reactive to isocyanate groups.

3. The polyurethane elastomer composition according to claim 2, wherein
the aromatic diisocyanate is selected from the group consisting of 2,4-toluylene-diisocyanate, 2,6-toluylene-diisocyanate, 4,4′-diphenylmethane-diisocyanate, 2,4′-diphenylmethane-diisocyanate, 4,4′-diphenylmethane-diisocyanate, 2,2′-diphenylmethane-diisocyanate, and a mixture thereof.

4. The polyurethane elastomer composition according to claim 2, wherein
the aromatic diisocyanate is 4,4′-diphenylmethane-diisocyanate, and
the polyether glycol is a polytetramethylene ether glycol (PTMEG) having a molecular weight of from 1800 to 2200.

5. The polyurethane elastomer composition according to claim 4, wherein
the molecular weight of the PTMEG is 2000.

6. The polyurethane elastomer composition according to claim 4, wherein
the an alkyl amine having at least two nitrogens with hydrogen reactive to isocyanate groups is selected from the group consisting of ethylene diamine, propylene diamine and diethylenetriamine.

7. The polyurethane elastomer composition according to claim 1, wherein
the trialkyl phosphate is triethyl phosphate and the epoxide is ethylene oxide.

8. The polyurethane elastomer composition according to claim 7, wherein
a content of the oligomeric phosphate obtained by reaction of a triethyl phosphate with phosphorous pentoxide and ethylene oxide is from 0.1 to 6.0% by weight of the composition.

9. The polyurethane elastomer composition according to claim 6, wherein
the trialkyl phosphate is triethyl phosphate and the epoxide is ethylene oxide.

10. The polyurethane elastomer composition according to claim 9, wherein
a content of the oligomeric phosphate obtained by reaction of a triethyl phosphate with phosphorous pentoxide and ethylene oxide is from 0.1 to 6.0% by weight of the composition.

11. The polyurethane elastomer composition according to claim 10, wherein
the content of the oligomeric phosphate obtained by reaction of a triethyl phosphate with phosphorous pentoxide and ethylene oxide is from 1.0 to 1.6% by weight of the composition.

12. The polyurethane elastomer composition according to claim 1, further comprising at least one additive selected from the group consisting of an antioxidant, a colorant, a metal scavenger, a lubricant, a plasticizer and a spin processing aid.

13. A method to prepare a flame-retarded polyurethane-urea elastomer, comprising:
adding an oligomeric phosphate obtained by reaction of a trialkyl phosphate with phosphorous pentoxide and an epoxide to a solution comprising at least the polyurethane elastomer and a solvent;
extruding the solution of the polyurethane elastomer and oligomeric phosphate; and
removing the solvent to obtain the flame retarded polyurethane elastomer.

14. The method according to claim 13, wherein the polyurethane-urea elastomer is a polymer obtained by polymerization of monomer components, comprising:
an aromatic diisocyanate;
a polyether glycol; and
an alkyl amine having at least two nitrogens with hydrogen reactive to isocyanate groups.

15. The method according to claim 14, wherein the aromatic diisocyanate is selected from the group consisting of 2,4-toluylene-diisocyanate, 2,6-toluylene-diisocyanate, 4,4′-diphenylmethane-diisocyanate, 2,4′-diphenylmethane-diisocyanate, 4,4′-diphenylmethane-diisocyanate, 2,2′-diphenylmethane-diisocyanate, and a mixture thereof.

16. The method according to claim 14, wherein the aromatic diisocyanate is 4,4′-diphenylmethane-diisocyanate, and
the polyether glycol is a polytetramethylene glycol (PTMEG) having a molecular weight of from 1800 to 2200.

17. The method according to claim 16, wherein
the molecular weight of the PTMEG is 2000.

18. The method according to claim 14, wherein
the an alkyl amine having at least two nitrogens with hydrogen reactive to isocyanate groups is selected from the group consisting of ethylene diamine, propylene diamine and diethylenetriamine.

19. The method according to claim 13, wherein
the trialkyl phosphate is triethyl phosphate and the epoxide is ethylene oxide.

20. The method according to claim 19, wherein
a content of the oligomeric phosphate added to the polyurethane-urea elastomer solution is from 0.1 to 6.0% by weight of a weight of the polyurethane-urea elastomer in the solution.

21. The method according to claim 13, further comprising:
adding at least one additive selected from the group consisting of an antioxidant, a colorant, a metal scavenger, a lubricant, a plasticizer and a spin processing aid to the polyurethane-urea elastomer solution.

22. The method according to claim 16, wherein the polyurethane-urea elastomer is prepared by a process comprising:
reacting the 4,4′-diphenylmethane-diisocyanate with the PTMEG having a molecular weight of from 1800 to 2200 to obtain a capped glycol prepolymer; and
polymerizing the capped glycol prepolymer by reaction with the alkyl amine having at least two nitrogens with hydrogen reactive to isocyanate groups to obtain the polyurethane-urea elastomer.

23. The method according to claim 22, wherein
the an alkyl amine having at least two nitrogens with hydrogen reactive to isocyanate groups is selected from the group consisting of ethylene diamine, propylene diamine and diethylenetriamine.

24. The method according to claim 22, wherein
a content of the 4,4′-diphenylmethane-diisocyanate is from 16.0 to 20.0 weight %, and
a content of the PTMEG is 80 to 84 weight %, relative to a total mass of the PTMEG and 4,4′-diphenylmethane-diisocyanate.

25. The method according to claim 22, wherein the solvent is dimethacetamide, and the dimethacetamide is added to the capped glycol prepolymer.

26. The method according to claim 25, wherein the extrusion comprises:
extruding the dimethacetamide solution of the polyurethane-urea elastomer through a die to form a fiber;
heat treating the extruded fiber to 190 to 385° C.; and
removing the dimethacetamide from the formed fiber.

27. An fiber, comprising:
a polyurethane elastomer; and
an oligomeric phosphate obtained by reaction of a trialkyl phosphate with phosphorous pentoxide and an epoxide.

28. The fiber according to claim 27, wherein
the trialkyl phosphate is triethyl phosphate, and
the epoxide is ethylene oxide.

29. The fiber according to claim 28, wherein
a % by weight of the oligomeric phosphate is 0.1 to 6.0% by weight of the fiber.

30. The fiber according to claim 29, wherein
the polyurethane-urea elastomer is a polymer obtained by polymerization of monomer components, comprising:
an aromatic diisocyanate;
a polyether glycol; and
an alkyl amine having at least two nitrogens with hydrogen reactive to isocyanate groups.

31. The fiber according to claim 30, wherein
the aromatic diisocyanate is 4,4′-diphenylmethane-diisocyanate;
the polyether glycol is a PTMEG having a molecular weight of from 1800 to 2200; and
the alkyl amine is a diamine selected from the group consisting of ethylene diamine, propylene diamine and diethylenetriamine.

32. The fiber according to claim 31, wherein the molecular weight of the PTMEG is 2000.

33. The fiber according to claim 31, further comprising at least one additive selected from the group consisting of an antioxidant, a colorant, a metal scavenger, a lubricant, a plasticizer and a spin processing aid.

34. A spun yarn comprising the fiber according to claim 27.

35. A spun yarn comprising the fiber according to claim 28.

36. A spun yarn comprising the fiber according to claim 30.

37. A spun yarn comprising the fiber according to claim 31.

38. A flame retardant fabric comprising the spun yarn of claim 34.

39. The flame retardant fabric of claim 38, wherein the spun yarn is present in an amount of from 1 to 50% by weight, with a remainder comprising one or more flame retardant hard yarns.

40. A flame retardant fabric comprising the spun yarn of claim 35.

41. The flame retardant fabric of claim 40, wherein the spun yarn is present in an amount of from 1 to 50% by weight, with a remainder comprising one or more flame retardant hard yarns.

42. A flame retardant fabric comprising the spun yarn of claim 36.

43. The flame retardant fabric of claim 42, wherein the spun yarn is present in an amount of from 1 to 50% by weight, with a remainder comprising one or more flame retardant hard yarns.

44. A flame retardant fabric comprising the spun yarn of claim 37.

45. The flame retardant fabric of claim 44, wherein the spun yarn is present in an amount of from 1 to 50% by weight, with a remainder comprising one or more flame retardant hard yarns.
